(19) United States
(12) Patent Application Publication
(10) Pub. No.: US 2003/0203681 A1
(43) Pub. Date: Oct. 30, 2003

(54) Battery terminal connector

(76) Inventor: Shih Tsung Liang, Chong Ho City (TW)

Correspondence Address: Shih Tsung Liang, P.O. Box 10-69, Chong Ho, Taipei, 235, TW

(21) Appl. No.: 10/135,313

(22) Filed: Apr. 26, 2002

(51) Int. Cl. H01R 4/38

(52) U.S. Cl. 439/768

(57) ABSTRACT

A battery terminal connector includes a bore formed by a peripheral wall for receiving a terminal of a vehicle battery, and one or more peripheral ribs or a helical rib or one or more ratchet ribs extended inward of the bore of the connector for engaging with the terminal of the battery and for securing the connector onto the terminal of the battery. A fastener may be engaged through the peripheral wall of the connector and engaged with the terminal of the battery, for further solidly securing the connector onto the terminal of the battery.

### BACKGROUND OF THE INVENTION

1. Field of the Invention

The present invention relates to a battery terminal connector, and more particularly to a battery terminal connector for securing to the batteries of the vehicles.

2. Description of the Prior Art

Various kinds of typical battery terminal connectors have been developed for attaching or coupling to the terminals of the batteries of the vehicles. The battery terminal connectors comprise a cylindrical block or barrel having a gap formed therein for forming two ends and having a flap provided on each of the ends thereof. A fastener may further be provided and engaged through the end flaps of the cylindrical barrel for securing the cylindrical barrel onto the battery terminals. One example of the battery terminal connectors is disclosed in U.S. Pat. No. 6,3464,720 to Liang.

U.S. Pat. No. 5,733,152 to Freitag discloses one of the other battery terminal connectors and comprises a complicated configuration including two semicircular sides each having an aperture formed therein and defined by a peripheral flange for engaging onto the battery terminals. A fastener is further required to be provided and engaged between the semicircular sides for solidly securing the connector onto the battery terminals. The connector should also include one or more gaps or slotted openings formed therein for allowing the connector to be engaged and secured onto the battery terminals.

The present invention has arisen to mitigate and/or obviate the afore-described disadvantages of the conventional battery terminal connectors.

### SUMMARY OF THE INVENTION

The primary objective of the present invention is to provide a battery terminal connector including a connector body for securing to the batteries of the vehicles, without slotted openings formed therein.

The other objective of the present invention is to provide a battery terminal connector including a connector body for securing to the batteries of the vehicles with one or more peripheral ribs or a helical rib extended inward of the connector body.

The further objective of the present invention is to provide a battery terminal connector including a connector body for securing to the terminals of the batteries of the vehicles with a fastener that is engaged and secured between the connector body and the terminals of the batteries of the vehicles.

In accordance with one aspect of the invention, there is provided a battery terminal connector comprising a connector body including a bore formed therein and defined by a peripheral wall for receiving a terminal of a battery, and including at least one peripheral rib extended inward of the bore of the connector body for engaging with the terminal of the battery, and for securing the connector body onto the terminal of the battery.

The peripheral rib is preferably a ratchet rib for solidly engaging with the terminal of the battery and for preventing the connector body from being disengaged from the terminal of the battery.

The peripheral rib may also be a helical rib for engaging onto the terminal of the battery by rotating the connector body relative to the terminal of the battery.

A fastener may further be provided and engaged through the peripheral wall of the connector body and engaged with the terminal of the battery, for further securing the connector body onto the terminal of the battery.

The connector body includes an aperture formed in the peripheral wall thereof and communicating with the bore thereof, the fastener includes a first leg engaged in the aperture of the connector body and engaged with the terminal of the battery.

The fastener further includes a second leg, and a slot formed between the first and the second legs, or, the fastener includes a head having the first leg extended therefrom, and having an opening formed therein.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a battery terminal connector in accordance with the present invention;

FIG. 2 is a cross sectional view taken along lines 2-2 of FIG. 3;

FIG. 3 is a cross sectional view taken along lines 3-3 of FIG. 2;

FIG. 4 is an exploded view illustrating the operation of the battery terminal connector; and

FIGS. 5, 6, 7, 8, 9, 10, 11 are exploded views illustrating the other arrangements of the battery terminal connector.

### DETAILED DESCRIPTION OF THE PREFERRED EMBODIMENT

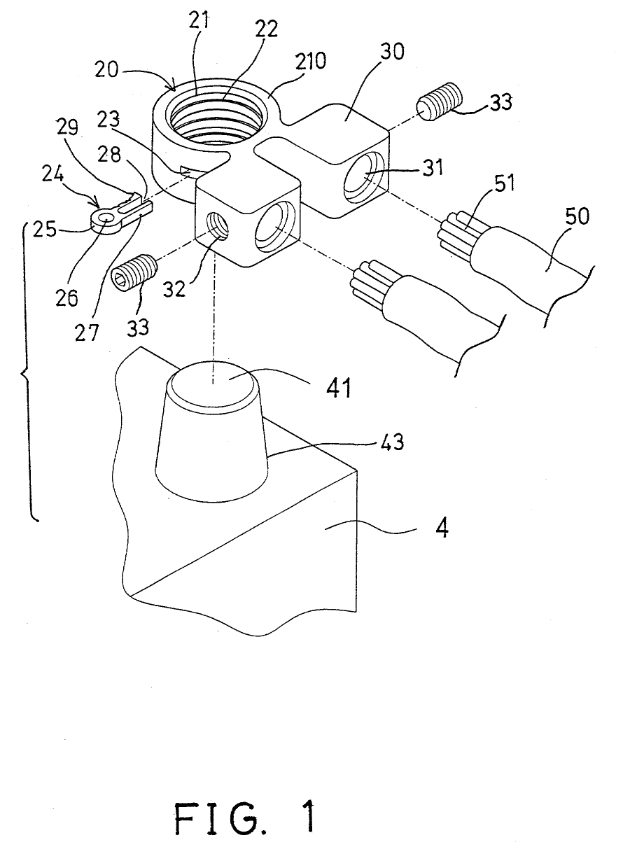

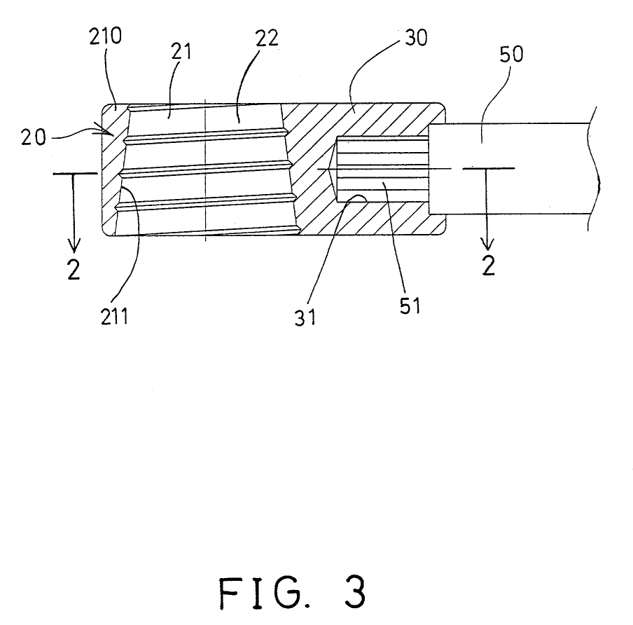

Referring to the drawings, and initially to FIGS. 1-3, a battery terminal connector in accordance with the present invention comprises a connector body 20 which may be formed into any kind of shapes, such as a cubic block or a cylindrical barrel or the like. The connector body 20 includes a cylindrical bore 21 formed therein, and formed or defined by a peripheral wall 210, for receiving the terminal 41 of the batteries 4, such as the batteries of the vehicles. It is to be noted that the connector body 20 does not include any slotted openings formed therein which are required to be formed in the typical connectors.

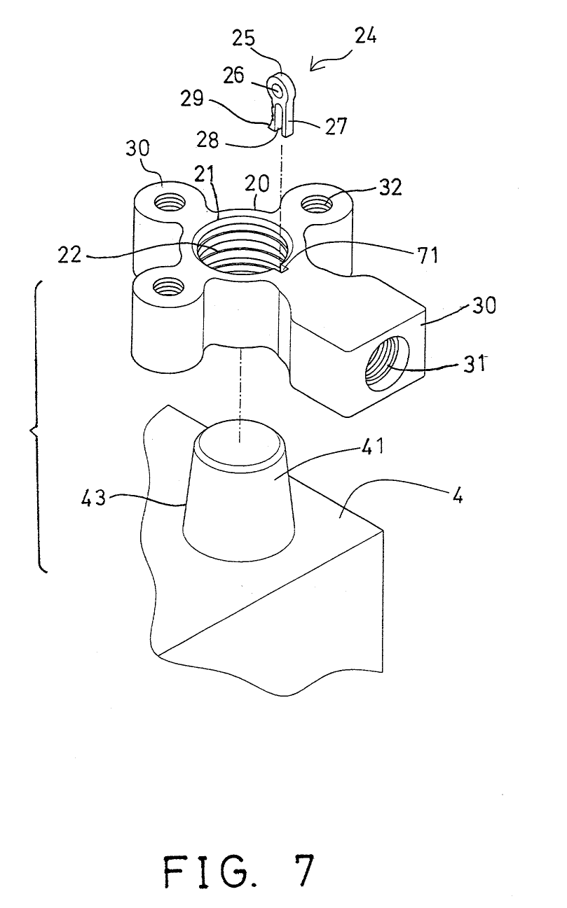

The connector body 20 may include one or more cable end sleeves 30 formed thereon or extended therefrom or secured thereto. The cable end sleeves 30 may each include one or more orifices 31 formed therein (FIGS. 1-7) for receiving and securing the electric wires 51 of the electric cable 50 therein. The cable end sleeves 30 may each further include one or more screw holes 32 formed therein and communicating with the orifices 31 thereof for receiving fasteners 33 which may be engaged with the electric wires 51 for further solidly securing the electric wires 51 to the cable end sleeves 30.

It is preferable that the bore 21 of the connector body 20 includes a frustum-shaped inner peripheral surface or inclined inner peripheral surface 211 formed therein which has a shape corresponding to or similar to that of the frustum-shaped outer peripheral surface or inclined outer peripheral surface 43 of the terminal 41 of the batteries 4, for allowing the frustum-shaped outer peripheral surface or inclined outer peripheral surface 43 of the terminal 41 of the batteries 4 to be solidly engaged with the corresponding frustum-shaped inner peripheral surface or inclined inner peripheral surface 211 of the connector body 20.

The connector body 20 further includes a number of peripheral ribs or a helical rib 22 formed therein and extended inward of the cylindrical bore 21 of the connector body 20 for solidly engaging or securing the connector body 20 onto the terminal 41 of the batteries 4. The peripheral ribs or the helical rib 22 preferably includes a ratchet configuration for allowing the connector body 20 to be easily engaged and secured onto the terminal 41 of the batteries 4, but may also be used for preventing the connector body 20 from being easily disengaged from the terminal 41 of the batteries 4.

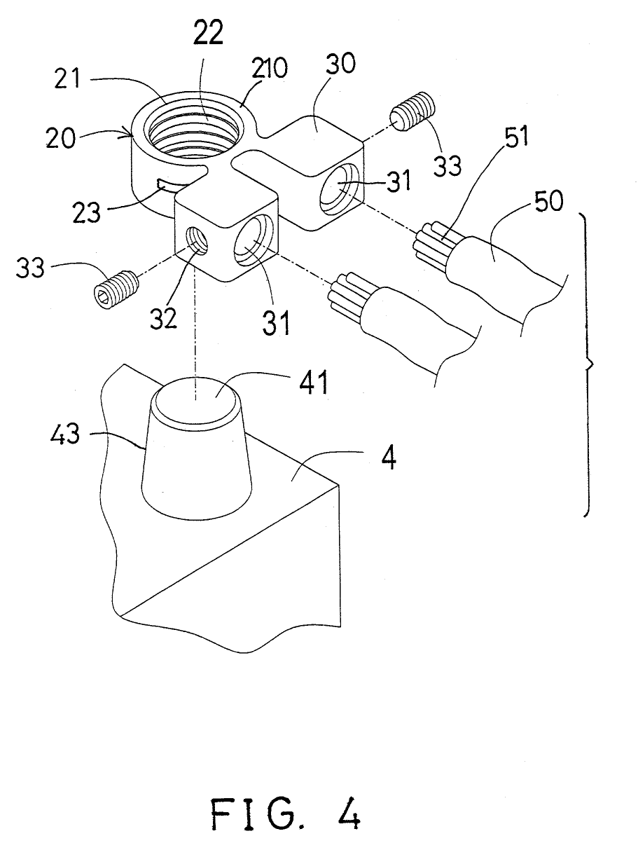

For example, as shown in FIG. 4, the connector body 20 may be engaged or secured onto the terminal 41 of the batteries 4 by directly forcing and engaging the ratchet peripheral ribs 22 of the connector body 20 onto the terminal 41 of the batteries 4, or by rotating and securing the helical rib 22 of the connector body 20 onto the terminal 41 of the batteries 4. The connector body 20 may thus be easily and solidly engaged and secured onto the terminal 41 of the batteries 4 without any further fasteners.

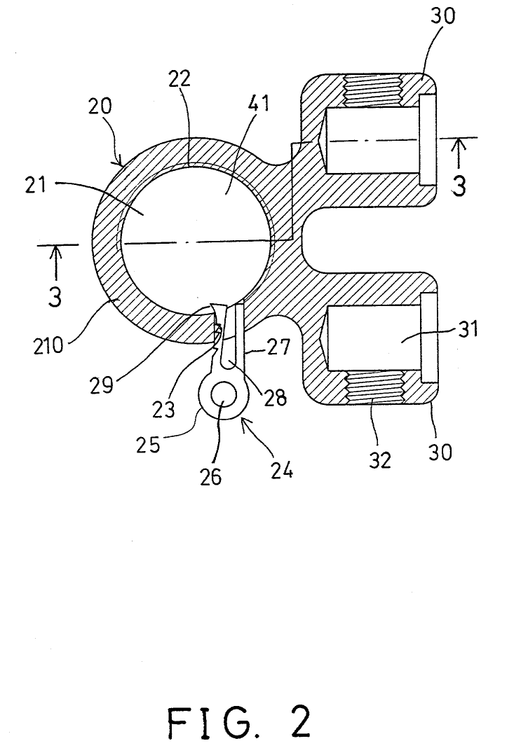

As shown in FIGS. 1, 2, 4, the connector body 20 may further includes an aperture 23 laterally formed therein, particularly formed through the peripheral wall 210 of the connector body 20, and communicating with the cylindrical bore 21 of the connector body 20. A fastener 24 (FIGS. 1, 2) may further be provided and engaged into the aperture 23 of the connector body 20, and engaged with the terminal 41 of the batteries 4, for further solidly securing the connector body 20 to the terminal 41 of the batteries 4.

For example, the fastener 24 may include a head 25 having an opening 26 formed therein for receiving a tread or a rope or a cable or the like, and a pair of legs 27 extended from the head 25, and a slot 28 formed between the legs 27, for allowing the legs 27 to include a suitable resilience. The legs 27 may be engaged in or resiliently clamped in the aperture 23 of the connector body 20. One of the legs 27 may further include a projection 29 extended therefrom for engaging into or for engaging with the terminal 41 of the batteries 4. The fastener 24 may thus be selectively or optionally provided for further solidly securing the connector body 20 to the terminal 41 of the batteries 4.

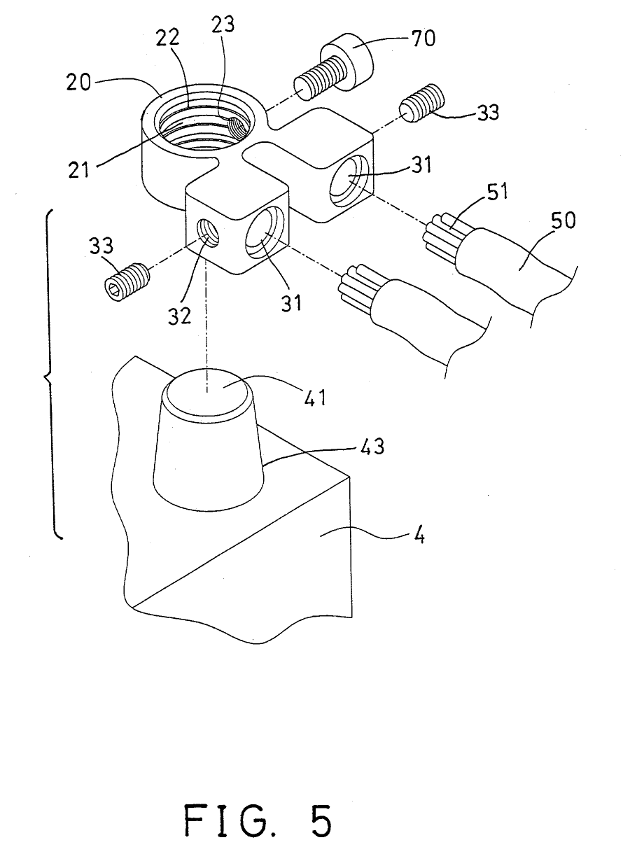

Referring next to FIG. 5, the fastener 70 may also be directly threaded with the aperture 23 of the connector body 20, and may also be engaged with the terminal 41 of the batteries 4, for selectively or optionally and solidly securing the connector body 20 to the terminal 41 of the batteries 4.

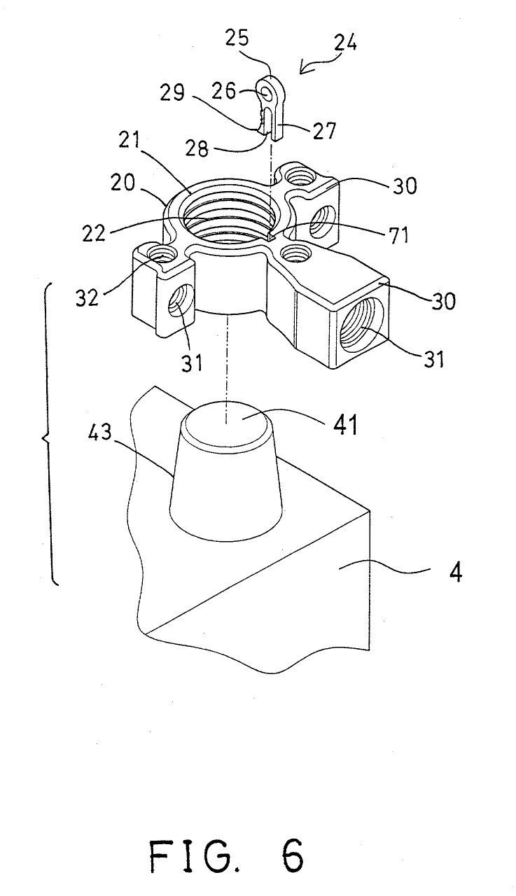

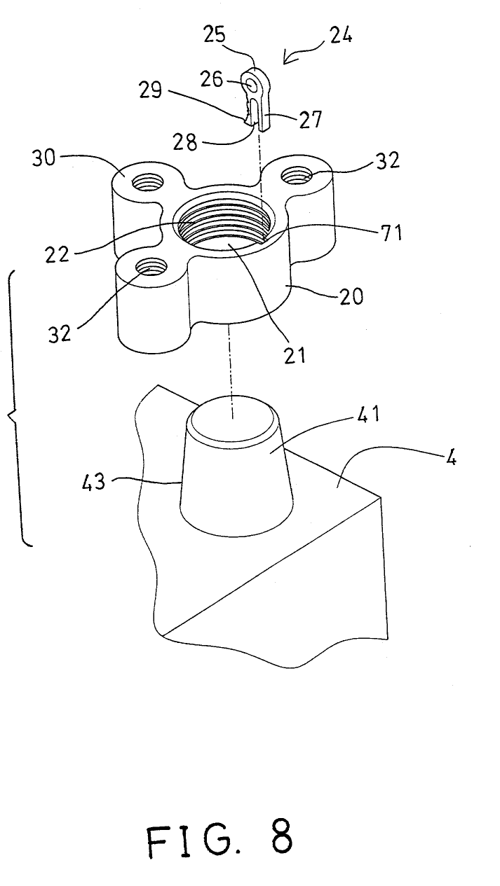

Referring next to FIGS. 6-8, the connector body 20 may also includes a groove or a notch 71 formed in the inner peripheral portion thereof and communicating with the bore 21 thereof for receiving the fastener 24. The fastener 24 may also include a projection 29 extended from one of the legs 27 thereof for engaging with the terminal 41 of the batteries 4 and for selectively or optionally and further solidly securing the connector body 20 to the terminal 41 of the batteries 4.

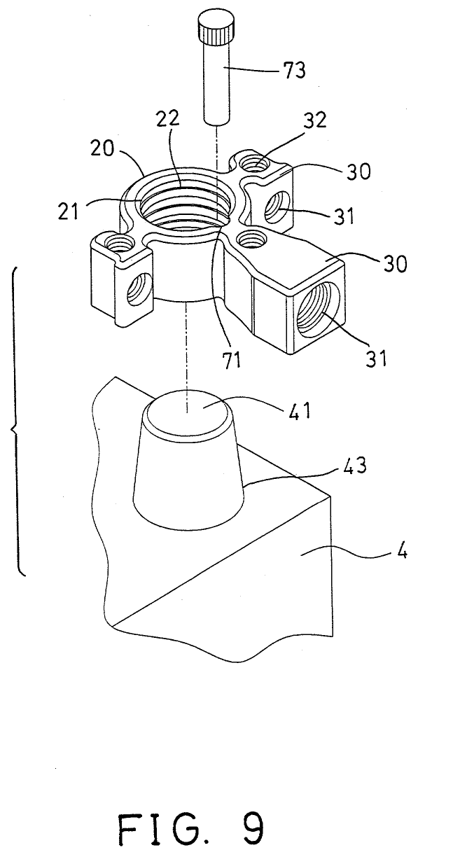

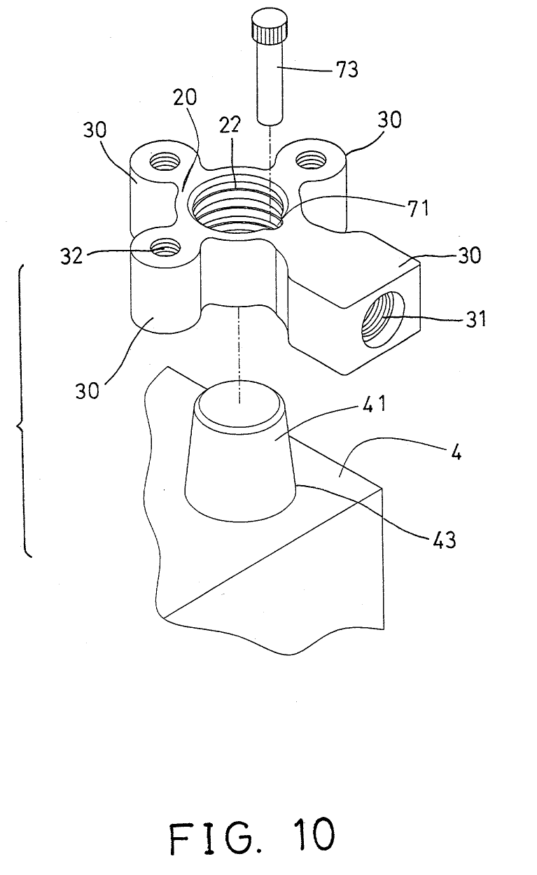

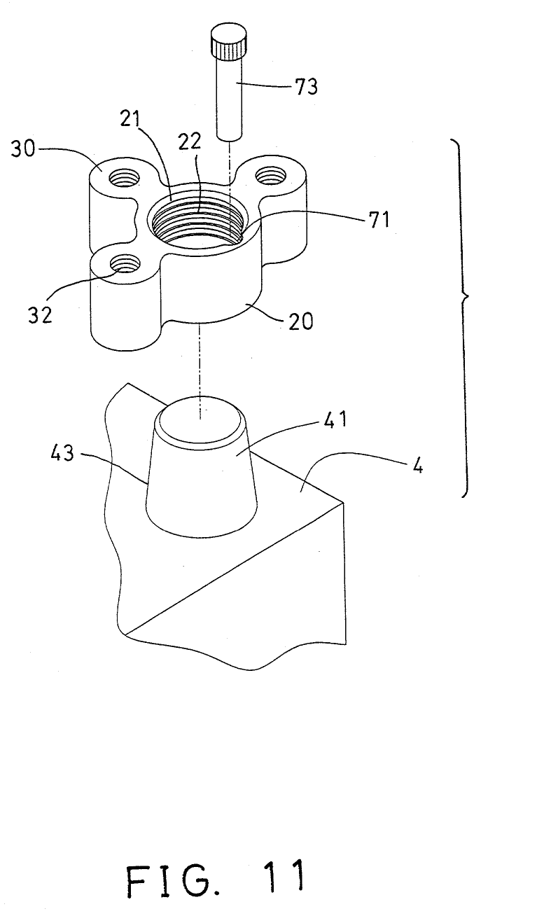

Alternatively, as shown in FIGS. 9-11, a pin or a rod or a rivet type fastener 73 may be directly engaged into the groove or the notch 71 that is formed in the inner peripheral portion of the connector body 20 and may be engaged with the terminal 41 of the batteries 4 for selectively or optionally and further solidly securing the connector body 20 to the terminal 41 of the batteries 4.

It is to be noted that the connector body 20 includes a circular cross section having no slotted openings formed therein, or having no openings or slots longitudinally formed through the wall 210 of the connector body 20, in which the slotted openings are required to be formed in the typical cable end connectors. The connector body 20 may also be directly secured onto the terminal 41 of the batteries 4 with the fastener 24, without the peripheral ribs or the helical rib 22.

Accordingly, the battery terminal connector in accordance with the present invention includes a connector body for securing to the batteries of the vehicles, without slotted openings formed therein. The connector body may be directly secured onto the terminal of the batteries by the ratchet peripheral ribs or the helical rib of the connector body. The other fasteners may be selectively and optionally provided for further solidly securing the connector body to the terminal of the batteries.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A battery terminal connector comprising:
a connector body including a bore formed therein and defined by a peripheral wall for receiving a terminal of a battery, and including at least one peripheral rib extended inward of said bore of said connector body for engaging with the terminal of the battery, and for securing said connector body onto the terminal of the battery.

2. The battery terminal connector according to claim 1, wherein said at least one peripheral rib is a ratchet rib for solidly engaging with the terminal of the battery and for preventing said connector body from being disengaged from the terminal of the battery.

3. The battery terminal connector according to claim 1, wherein said at least one peripheral rib is a helical rib for engaging onto the terminal of the battery by rotating said connector body relative to the terminal of the battery.

4. The battery terminal connector according to claim 1 further comprising a fastener engaged through said peripheral wall of said connector body and engaged with the terminal of the battery, for further securing said connector body onto the terminal of the battery.

5. The battery terminal connector according to claim 4, wherein said connector body includes an aperture formed in said peripheral wall thereof and communicating with said bore thereof, said fastener includes a first leg engaged in said aperture of said connector body and engaged with the terminal of the battery.

6. The battery terminal connector according to claim 5, wherein said fastener further includes a second leg, and a slot formed between said first and said second legs.

7. The battery terminal connector according to claim 5, wherein said fastener includes a head having said first leg extended therefrom, and having an opening formed therein.

8. A battery terminal connector comprising:
a connector body including a bore formed therein and defined by a peripheral wall for receiving a terminal of a battery, and including an aperture formed in said peripheral wall thereof and communicating with said bore thereof, and
a fastener engaged through said aperture of said peripheral wall of said connector body and engaged between said connector body and the terminal of the battery, for securing said connector body onto the terminal of the battery.

9. The battery terminal connector according to claim 8, wherein said fastener includes a first leg engaged in said aperture of said connector body and engaged with the terminal of the battery.

10. The battery terminal connector according to claim 9, wherein said fastener further includes a second leg, and a slot formed between said first and said second legs.

11. The battery terminal connector according to claim 9, wherein said fastener includes a head having said first leg extended therefrom, and having an opening formed therein.

12. The battery terminal connector according to claim 8, wherein said connector body includes at least one peripheral rib extended inward of said bore of said connector body for engaging with the terminal of the battery, and for further securing said connector body onto the terminal of the battery.

13. The battery terminal connector according to claim 12, wherein said at least one peripheral rib is a ratchet rib for solidly engaging with the terminal of the battery and for preventing said connector body from being disengaged from the terminal of the battery.

14. The battery terminal connector according to claim 12, wherein said at least one peripheral rib is a helical rib for engaging onto the terminal of the battery by rotating said connector body relative to the terminal of the battery.
